(19) United States
(12) Patent Application Publication
(10) Pub. No.: US 2010/0264390 A1
(43) Pub. Date: Oct. 21, 2010

(54) SAFETY RAILING FOR EXCAVATED AREAS

(76) Inventor: Victor M. CERDA, Houston, TX (US)

Correspondence Address: DANIEL B. SCHEIN, PH.D., ESQ., INC., P. O. BOX 68128, Virginia Beach, VA, 23471, US

(21) Appl. No.: 12/708,493

(22) Filed: Feb. 18, 2010

Related U.S. Application Data
(60) Provisional application No. 61/153,575, filed on Feb. 18, 2009.

(51) Int. Cl. E04H 17/14; B23P 11/00

(52) U.S. Cl. 256/24; 29/428

(57) ABSTRACT

A guard rail that mounts to a trench shield or shore. Trench shields and shores are used to maintain the patency of excavated areas. The length and/or spacing of the panels of the guard rail system can be adjusted to match the upper dimensions of a trench shield or shore to which the guard rail system can be mounted. The guard rail comprises panels that are readily assembled and disassembled, permitting ready reconfiguration, and permitting the system to be collapsed into a small area for storage and transportation. Use of the present invention does not require additional space around an excavated area or opening in which the system is mounted. A connection fitting for workers and equipments is provided on the rail system, as the secure attachment of the system to a trench shield or shore can be utilized to provide a convenient and secure means by which to workers and their equipment can be readily tracked and facilitates rescue if needed. An access gate is included in one panel to provide for convenient and safe ingress and egress while maintaining a secure barrier about the perimeter of an excavated area.

### PRIORITY

This application claims priority of U.S. Provisional Application No. 61/153,575, filed Feb. 18, 2009, entitled “Safety Railing For Excavated Areas.”

### FIELD OF THE INVENTION

The present invention relates generally to devices for protecting workers doing any type of work around, as well as in, excavations, such as below ground repairs, maintenance or installation of any type, such as but not limited to trenching, building construction, bore pits, manhole installations, or pipe line maintenance work. The present inventions relate more particularly to a safety railing for excavated areas to prevent accidental falls into excavated areas. The present inventions include temporary safety railing systems that can readily interact with mechanisms, such as but not limited to trench shields and shoring, which maintain the patency of excavated areas to thereby provide safety both in and around excavated areas.

### BACKGROUND

For excavated areas that require persons to enter into the excavation it is necessary to protect against potential cave-ins that can cause serious injury or even loss of life to persons in the excavated area, and further to prevent persons and equipment from accidentally falling into the excavated area. Due to advances in excavating equipment (hydraulic backhoes, etc.), it is possible to quickly dig deep excavated areas with relatively vertical walls and crisp edges. However, cave-ins can readily occur if the walls of the excavated area are not supported, and with the speed of current excavating equipment, busy workers and equipment operators on a job site might not be aware of a recently created trench. If lighting is not optimal, work conditions are crowded, inter alia, the chances increase of a person or equipment falling into an excavated area. Even if there is no person and/or equipment in an excavated area when it collapses, this can create an expensive interference with maintenance or construction operations. In fact, the United States Code of Federal Regulations addresses these concerns at 29 CFR §1926, Subpart P, and provides associated definitions and guidelines.

Therefore, various devices are utilized in maintenance and construction trenches to support the walls against collapse, commonly referred to as trench shielding and shoring devices. Devices used for trench safety may be referred to by a variety of terms, such as but not limited to trench shields, trench shores, shoring shields, skeleton boxes, walers, vertical shores, slide rail systems and manhole boxes, etc. Many in the field consider trench shields to comprise static devices that are placed in an excavated area, and consider trench shores to comprise active systems that have hydraulic shores that push vertical rails and/or walls out to meet the walls of an excavated area. Some examples of trench shoring equipment can be found in U.S. Pat. Nos. 7,101,119 and 7,258,511, both to the present inventor. A manufacturer of state of the art trench shields and shores and related equipment for excavation safety is Cerda Industries, Inc. of Houston, Tex., and exemplary equipment is displayed on its web site www.cerdaindustries.com and in downloadable pamphlets.

While trench shields and shores prevent collapse of the walls of excavated areas, it is also desired to prevent persons and equipment from accidentally falling into the excavated areas. Similarly, to prevent accidents, openings in elevated areas are protected by guard rail systems. Various solutions include temporary guard rail systems that are placed around the outer perimeter of the excavated area or openings in elevated areas, such as but not limited to systems disclosed in U.S. Patent Application publication 2002/0104987 to Purvis; U.S. Patent Application publication 2004/0041141 to Cannon; U.S. Pat. Re 39,842 to Purvis et al; U.S. Pat. No. 5,683,074 to Purvis et al; U.S. Pat. No. 7,272,800 to Phinney et al; and U.S. Pat. No. 7,554,257 to Kenton. The patents and published patent application of Purvis et al disclose a temporary guard rail system that can be attached to the floor of a building under construction, and can be disassembled. The published patent application of Cannon discloses a temporary safety guard rail for construction sites comprising horizontal rails attached to vertical posts, while the patent to Phinney et al discloses a protective guard rail for openings in roofs and floors and comprising horizontal rails attached to corner vertical members 10-18. The patent to Kenton discloses a portable safety rail system comprising guard rails for use at construction sites. All documents, regulations, web sites, and product brochures and related information mentioned herein are incorporated by reference as if reproduced verbatim in full herein.

A significant problem with prior art safety guard rail systems is that they must be securely mounted to a firm surface around an excavated area or elevated opening; otherwise they can be moved if contacted by equipment or people. Heavy equipment is commonly used around excavated areas or elevated openings during construction and maintenance, and individuals around such areas or openings, particularly those entering and leaving the area inside the guard rail, often support themselves with and/or pull on such guard rails. Therefore, both the guard rail and its mounting should be robust. In fact, in the aforementioned U.S. Pat. No. 5,683,074, it states that OSHA has become so alarmed that regulations have been promulgated to require temporary railings on all open elevated building structures that will withstand at least two hundred pounds pressure without failing. Further, where the surface surrounding an excavated area is not strong, the guard rail is not as safe as desired unless substantial effort is placed into securing it. When the surface surrounding an excavated area is strong, such as concrete, prior art systems require drilling or other modification to mount the guard rail to prevent movement; damage done by modification of such surfaces needs to be fixed afterwards. Moreover, mounting of a guard rail around an excavated area takes more space than the excavation requires, and also requires a larger rail than if the guard rail system matched the dimensions of the excavation. Another significant problem is that many excavations are not surrounded by a suitable strong surface, such as concrete or steel plates, to which a rail system can be readily fixed.

Therefore, an object of the present inventions is to provide a temporary safety guard rail system that overcomes deficiencies of prior art guard rail systems, particularly guard rail systems for use to protect excavated areas. More particularly, it is an object of the present inventions to provide a safety guard rail system that is easy to install and easy to remove, and which does not require modification of the surrounding perimeter of an excavated area. It is a further object of the present invention to provide a robust safety guard rail system that facilitates intentional passage of workers into and out of an excavated area while guarding against unintentional ingress of people or objects into the excavated area. It is a further object of the present invention to increase the safety of workers accessing an excavated area by facilitating a secure hold to a surrounding guardrail. Other objects and advantages of the present inventions arise from the following description, such as but not limited to more compact and flexible systems that reduce materials used, while providing a more attractive and safe overall product.

### SUMMARY OF THE INVENTION

In a first aspect, the present inventions include a guard rail system having a plurality of walls or panels operatively connected to form an enclosure that fits within the size and shape of an excavated area to be maintained and secured. In a preferred embodiment, the guard rail system includes mounts for connection to a trench shield or shoring system for use in maintaining the patency of an excavated area (various equivalent terms may be used in place of guard rail; non-limiting examples include safety rail, hand rail, safety fence, safety enclosure, etc.). Preferably, the walls of the guard rail system are of sufficient height to be readily visible to surrounding workers and equipment operators, wherein the height is sufficient to block a worker from falling thereover into an excavated area or opening surrounded by the “guard rail.” The system is preferably robust enough to support the weight of a worker, and preferably can support the weight of more than one worker, leaning or grasping on to it in various locations, and preferably provides a passage that can be opened or closed as needed to facilitate ingress and egress from an excavated area guarded thereby. In an embodiment, connection and/or support means are provided for connecting workers or equipment to the guard rail system so as to limit the depth of descent into an excavated area or opening, provide ready access to equipment and/or facilitate controlled ingress and/or egress to an excavated area or opening guarded by the system of the present invention. In an embodiment, the length and spacing of the walls of the guard rail system can be adjusted to match the upper dimensions of a trench shield or shore to which the guard rail system can be mounted.

Other features and advantages of the present invention summarized above will be more readily apparent and appreciated upon reading of the following additional description of preferred exemplified embodiments of the invention and upon reference to the accompanying drawings herein.

### BRIEF DESCRIPTION OF DRAWINGS

FIG. 1 is a perspective view of an exemplary embodiment of a temporary safety guard rail system of the present invention shown mounted on an example trench shield.

FIG. 2 is a perspective view of the temporary safety guard rail system of FIG. 1.

FIG. 3 is an exploded perspective view of the temporary safety guard rail system of FIG. 2.

FIG. 4 is a plan view of the front panel of FIG. 2.

FIG. 5 is a partial plan view detail of a trench access threshold that includes a D-ring assembly as shown in the front panel of FIG. 4.

FIG. 6 is a perspective view of the front panel shown in FIG. 4.

FIG. 7 is an exploded perspective detail view of the gate assembly of the temporary safety guard rail system of FIG. 2.

FIG. 8 is a perspective detail view of the gate and gate hinge of FIG. 7.

FIG. 9 is a perspective detail view of a stabilizer fork of the front panel of FIG. 7.

FIG. 10 is a side elevation view of the back panel of the temporary safety guard rail system of FIG. 2.

FIG. 11 is a perspective view of the back panel shown in FIG. 10.

FIG. 12 is a first partially exploded view of a side panel, or spreader panel, of FIG. 2 in an extended configuration.

FIG. 13 is a perspective view of the fixed dual spreader arm of the side panel of FIG. 12.

FIG. 14 is a perspective view of an extendible upper arm and an extendible lower arm, or inner spreader members, of the side panel of FIG. 12.

FIG. 15 is a second perspective view of the side panel, or spreader panel of FIG. 2, in a contracted configuration.

FIG. 16 is an exploded perspective detail view of a corner post assembly shown in the temporary safety guard rail system of FIG. 2.

FIG. 17 is a second exploded detail view of the corner post assembly of FIG. 16 from a different perspective.

FIG. 18 is a flow diagram of an exemplary process that is used to safeguard an open hole or trench using a described embodiment of the temporary safety guard rail system of the present invention.

### ADDITIONAL DESCRIPTION OF PREFERRED EMBODIMENTS

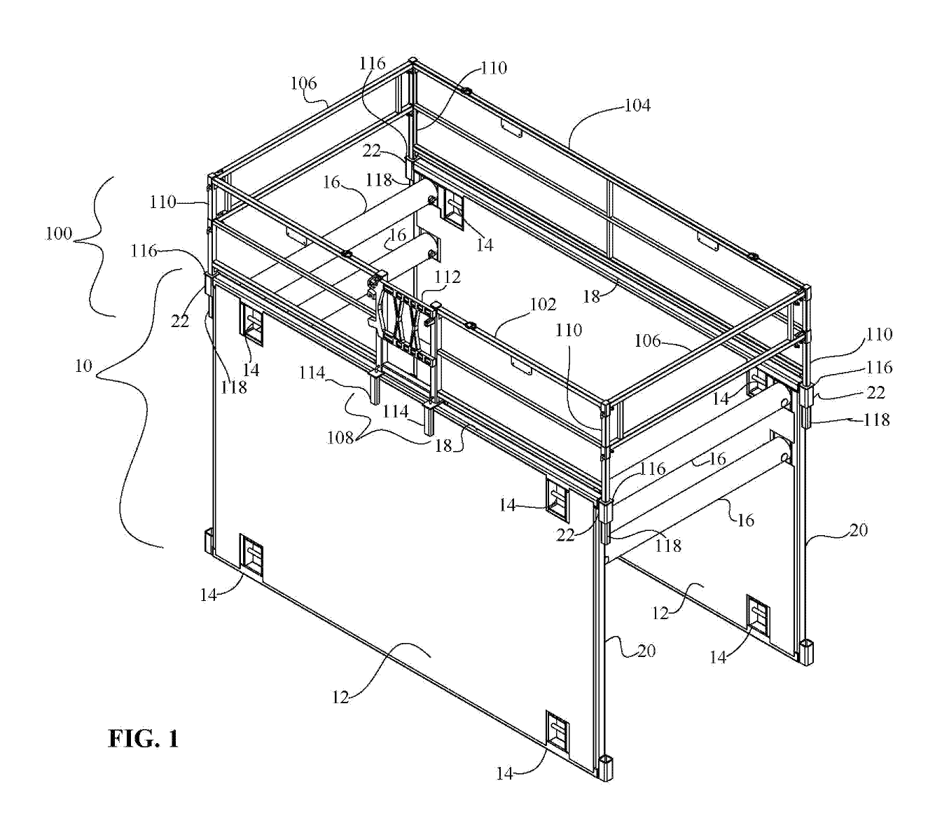

FIG. 1 is a perspective view of an exemplary embodiment of a safety rail system 100 of the present invention shown mounted on a conventional trench shield 10. As shown in FIG. 1, trench shield 10 is of conventional construction, having spreaders 16 that connect and maintain two trench shield panels 12 at a desired separation. Trench shield 10 includes one or more hitch points 14 that allow trench shield 10 to be lowered, e.g., by a crane or a bull-dozer, into a recently excavated hole or trench to protect against a collapse of the earthen walls of the excavated area, i.e., to maintain the patency of the excavated area. In this manner, a secure working area is established within the hole or trench between the respective trench shield panels that is protected from cave-ins should the walls of the hole, or trench collapse.

As further shown in FIG. 1, once the trench shield has been lowered into a recently excavated hole or trench, a mounting pin 118 located on each respective corner post 110 of safety rail system 100 is inserted into a respective sleeve, such as mounting sleeve 22, added to the trench shield in FIG. 1, to securely mount safety rail system 100 flush and level with an upper edge 18 of the respective trench shield plates. A base plate 116 mounted to each of the respective corner posts above the respective trench shield mounting pins limits the travel of corner posts 100 into mounting sleeves 22, and preferably provides a flush and level mount of safety rail system 100 to an upper edge 18 of the respective trench shield panels.

As further shown in FIG. 1, safety rail system 100 includes a front panel 102, a back panel 104, and two variable length side panels 106. Front panel 102, is mounted flush and level with an upper edge 18 of a first shield panel via corner posts 110 inserted into mounting sleeves 22 added to the first trench shield panel. Back panel 104 is mounted flush and level with an upper edge 18 of a second trench shield panel via corner posts 110 inserted into mounting sleeves 22 added to the second trench shield panel. Each variable length side panel 106 is mounted between corner posts of front panel 102 and a back panel 104 positioned across from each other on opposite sides of the secured trench area, as described in greater detail below.

Front panel 102 includes a hinge and gate assembly 112 mounted across a trench access threshold provided in front panel 102, as described in greater detail below. Stabilizer forks 114 project down from vertical members forming the trench access threshold of the front panel, so as to provide a stable and reinforced trench access threshold mount on opposite sides of the trench shield panel to which front panel 102 is attached. As described in greater detail below, workers entering or leaving via the trench access threshold and hinge and gate assembly 112 can attach their harness leashes to a pivoting D-ring mounted in the trench access threshold.

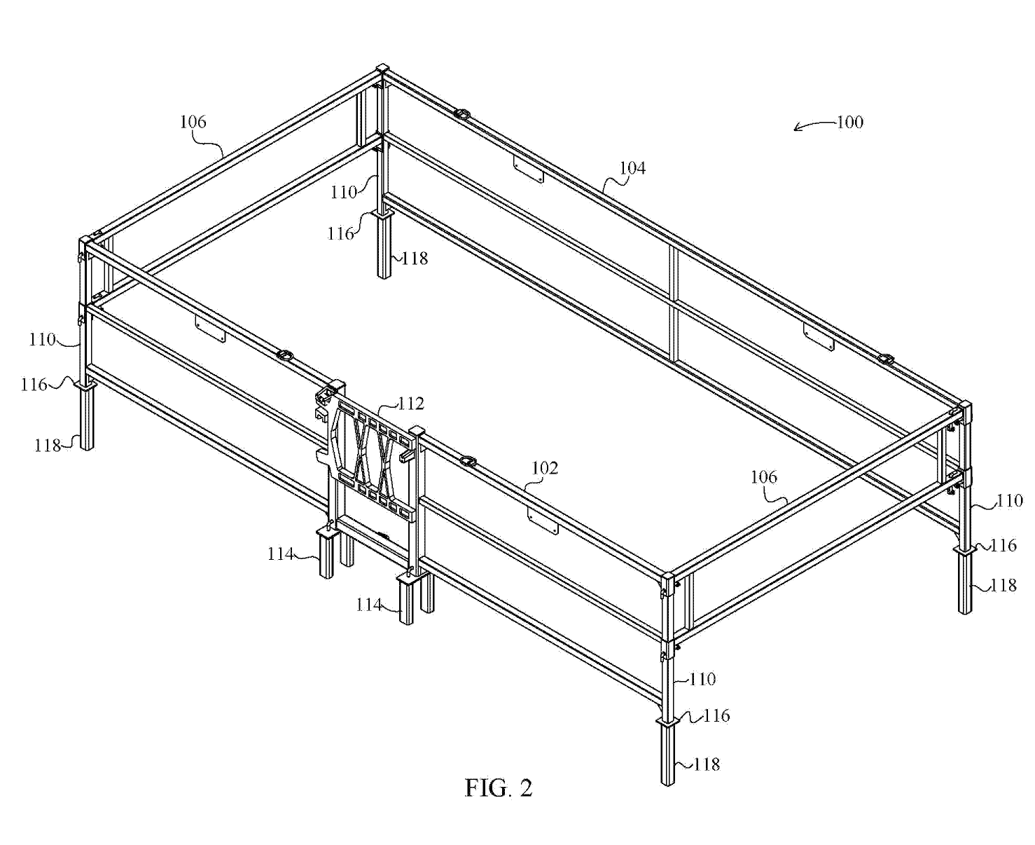

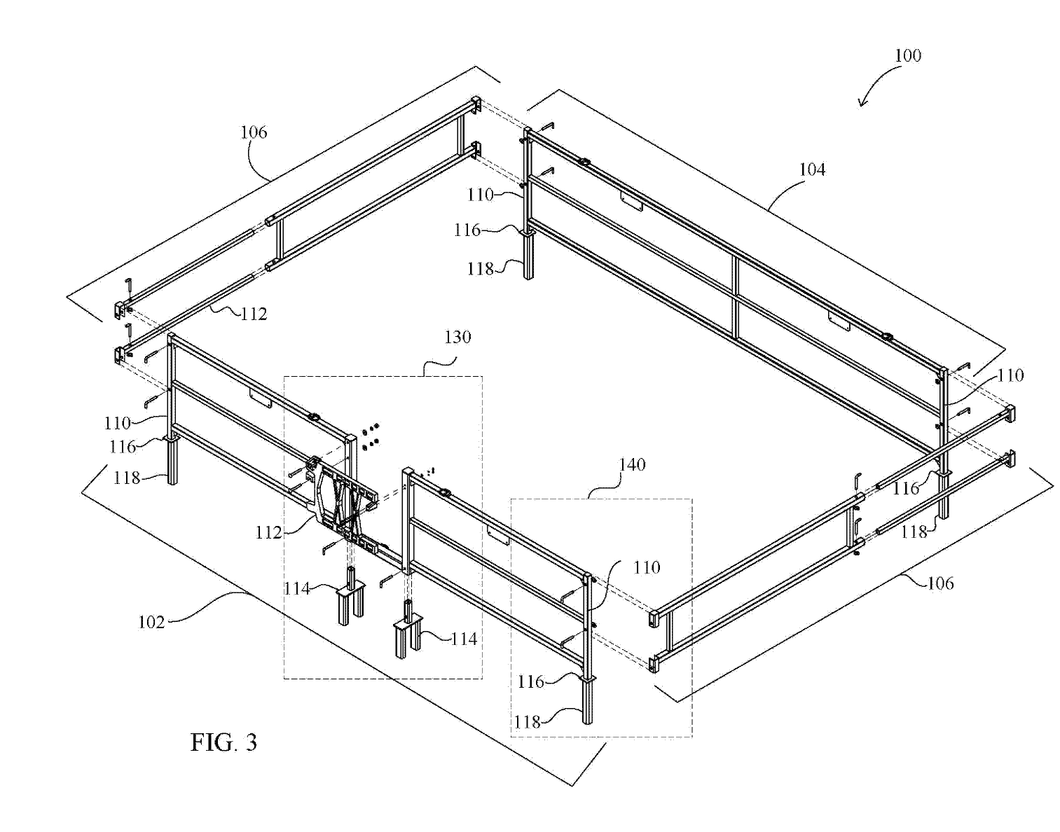

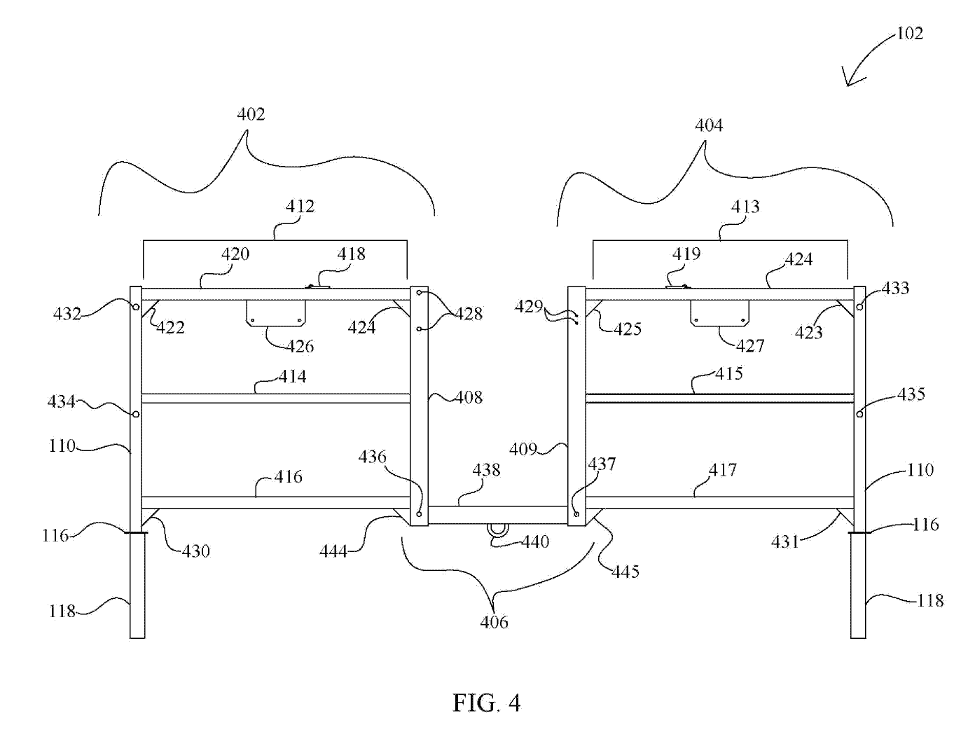

FIG. 2 is a perspective view of the temporary safety guard rail system of FIG. 1 separate from the trench shield shown in FIG. 1. FIG. 3 is an exploded perspective view of the temporary safety guard rail system of FIG. 2. Features shown in FIG. 2 and FIG. 3 are described with respect to FIG. 4 through FIG. 17, below.

FIG. 4 is a plan view of a front panel shown in the temporary safety guard rail system of FIG. 1, FIG. 2 and FIG. 3. As shown in FIG. 4, front panel 102 includes a first railing component 402 and a second railing component 404 connected to, and separated by, a trench access threshold, 406.

First railing component 402 includes a corner post 110 and a first trench access post 408 joined together by an upper railing assembly 412, a middle railing 414 and a lower railing 416. Upper railing assembly 412 is connected at one end to the top of vertical rail 111 of corner post 110, the connection is structurally reinforced by a triangular brace 422. Upper railing assembly 412 is connected at an opposite end to the top of first trench access post 408, the connection is structurally reinforced by a triangular brace 424. Middle railing 414 is connected at one end to a midsection of vertical rail 111 of corner post 110, and at an opposite end to a mid-section of first trench access post 408. Lower railing 416 is connected at one end to the bottom of vertical rail 111 of corner post 110, and at an opposite end to a bottom of first trench access post 408. The connections between lower railing 416 and vertical rail 111 and between lower railing 416 and first trench access post 408 are structurally reinforced by triangular brace 430 and triangular brace 444, respectively.

Corner post 110 includes a vertical rail 111, a base plate 116, a mounting pin 118, an upper through hole 432 and a lower through hole 434. A bottom of vertical rail 111 is centered on and connected to an upper horizontal face of base plate 116. Mounting pin 118 is centered on and connected to a lower horizontal face of base plate 116. The exterior perimeter of base plate 116 is greater that the exterior circumference of mounting pin 118. The exterior perimeter of base plate 116 is also greater than the exterior circumference of vertical rail 111 at the junction of base plate 116 and vertical rail 111. Upper through hole 432 in vertical rail 111 is positioned near a upper end of vertical rail 111 and is of a diameter sufficiently large to pass a locking pin from a front face of front panel 102 to a rear face of front panel 102. Lower through hole 432 is positioned near a mid-point of vertical rail 111 between the top of vertical rail 111 and the bottom of vertical rail 111 to which base plate 116 is attached. Embodiments of safety rail system 100 may include additional, or fewer through holes in vertical rail 111 depending on the number of side panel rails to be connected to vertical rail 111.

Base plate 116, having an exterior perimeter greater than the exterior circumference of mounting pin 118, limits the travel of corner post 110 into a mounting sleeve 22 added to a trench shield panel 12, and, as described above, provides a flush and level mount with the top edge of mounting sleeves 22. In embodiments where one or more of vertical rail 111 and mounting pin 118 are constructed of hollow tubing, e.g., square or round tubing, base plate 116 includes a through hole extending from the upper horizontal face of base plate 116 to the lower horizontal face of base plate 116 that provides connectivity between the hollow cavity of vertical rail 111 and the hollow cavity of mounting pin 118. As least one function of the through hole in base plate 116 is to facilitate the drainage of water condensation and/or standing water within the respective hollow cavities.

First trench access post 408 of first railing component 402 is preferably constructed of hollow tubing and includes safety gate hinge mount through holes 428 and stabilizer fork mount through hole 436. Safety gate hinge mount through holes 428 in first trench access post 408 are positioned near a upper end of first trench access post 408 and are of a diameter sufficiently large to pass fasteners, e.g., bolts, used to mount hinge and gate assembly 112, as described below. Stabilizer fork mount through hole 436 in first trench access post 408 is positioned near the bottom of first trench access post 408 and is of a diameter sufficiently large to pass a fastener, e.g., a locking pin optionally secured with a cotter pin, that can be used to secure first trench access post 408 to a stabilizer fork 114, as described below.

Upper railing assembly 412 preferably includes a D-ring bracket 418 and a notice mounting plate 426. D-ring bracket 418 is connected to a horizontal upper face of upper railing assembly 412 to provide a connection point for use in lifting front panel 102 and, in combination with other D-rings, for use in lifting the entire safety rail system. Notice mounting plate 426 is connected to a horizontal lower face of upper railing assembly 412 to provide a support for attaching, for example, warning signs and reflectors.

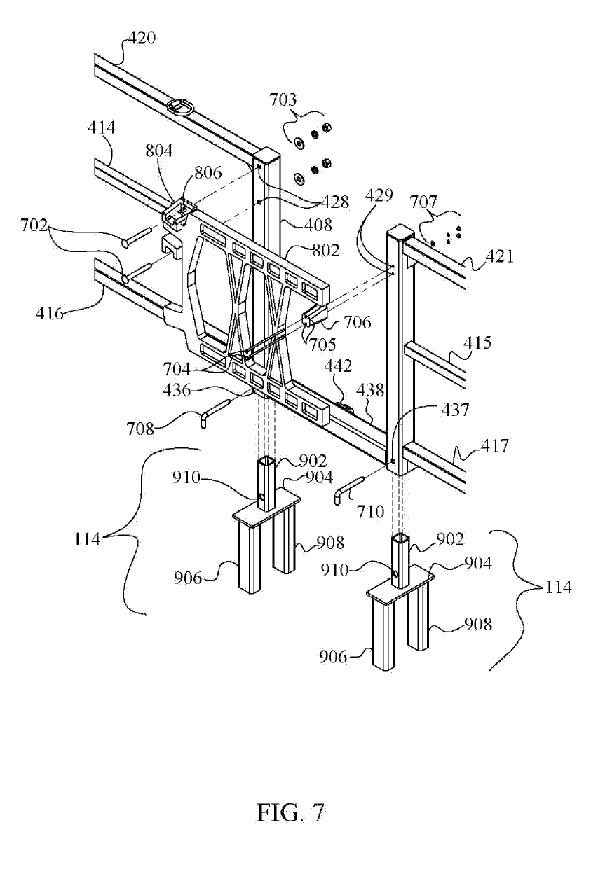

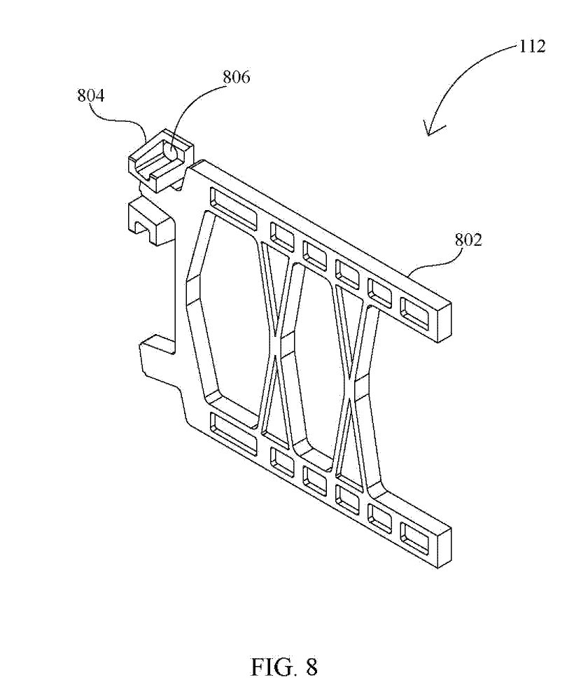

As shown in FIG. 4, second railing component 404 is essentially a mirror image of first railing component 402 and includes a corner post 110 and a second trench access post 409 joined together by an upper railing assembly 413, a middle railing 415 and a lower railing 417. The features of second railing component 404 are substantially similar to the features described above with respect to first railing component 402 and, therefore, will not again be described. Features of second railing component 404 that correspond to like features in first railing component 402 have been assigned an odd-numbered numeric label that is a single digit increment greater than the label assigned the corresponding feature in first railing component 402. One difference between second railing component 404 and first railing component 402 is that through holes 429 in second trench access post 409 are used to connect a rest support 706 for door 802 of hinge and gate assembly 112, as described above with respect to FIG. 7 and FIG. 8.

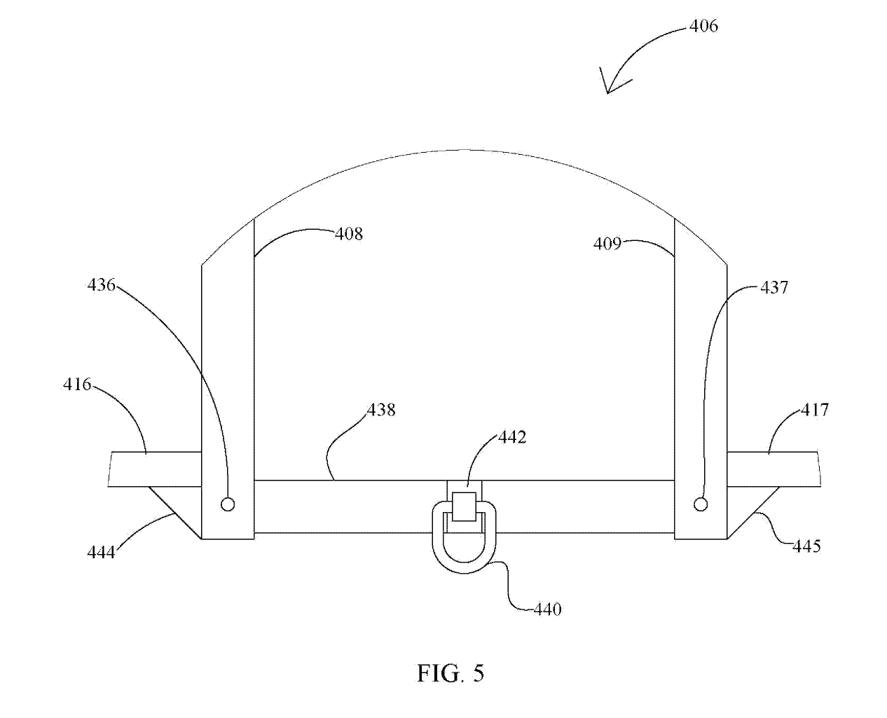

FIG. 5 is a plan view detail of trench access threshold 406 with a D-ring assembly. As shown in FIG. 5, trench access threshold 406 includes a trench threshold 438 that joins first railing component 402 and second railing component 404 by connecting a bottom of first trench access post 408 to a bottom of second trench access post 409. A D-ring bracket 442 with D-ring 440 is attached to a vertical face of trench threshold 438, and front panel 102 is attached to a trench shield so that the D-ring is facing towards the open trench/hole. In this manner the D-ring 440 is used to connect a safety harness of workers entering the trench via trench access threshold 406.

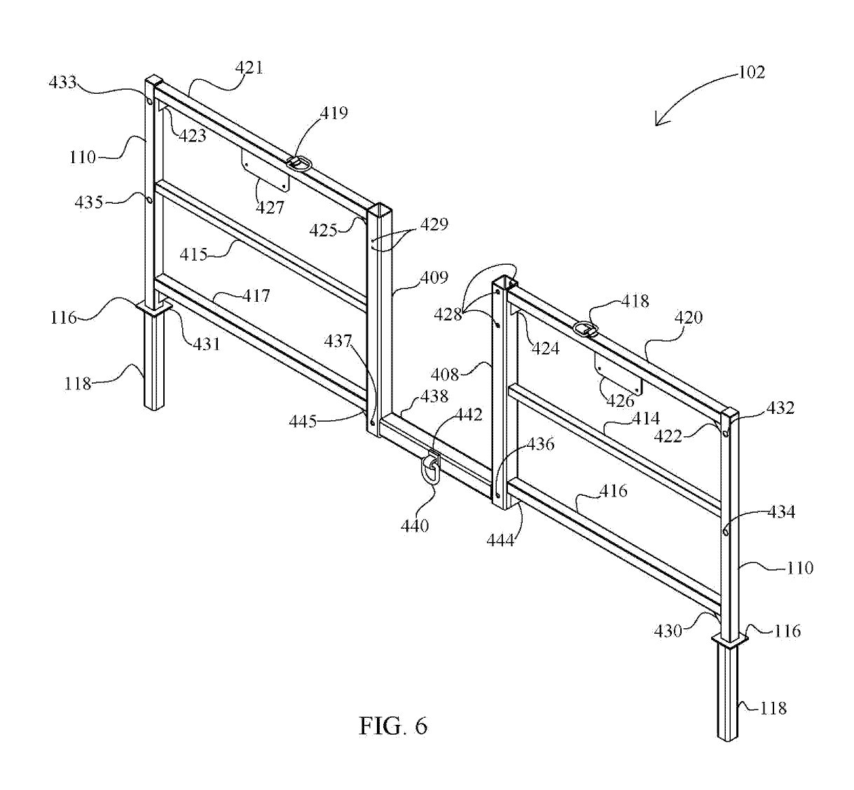

FIG. 6 is a perspective view of the front panel described above with respect to FIG. 4. As shown in FIG. 6, the a large number of the components of a front panel embodiment may be constructed of square hollow tubing, however, other types of solid bar stock and/or hollow bar stock of a wide range of materials may be used.

FIG. 7 is an exploded perspective detail view of a hinge and gate assembly 112 that is mounted in the trench access threshold provided in front panel 102, as shown in FIG. 3 at 130. As shown in FIG. 7, hinge 804 is mounted to first trench access post 408 of front panel 102 by aligning through holes 806 in hinge 804 with through holes 428 in first trench access post 408, inserting threaded bolts 702 through the aligned holes, and tightening each of bolts 702 with a washer, lock-washer and nut combination 703. A rest support 706 for door 802 of hinge and gate assembly 112 is mounted to second trench access post 409 of front panel 102 by aligning through holes 705 in rest support 706 with through holes 429 in second trench access post 409, inserting threaded bolts 704 through the aligned holes, and tightening each of bolts 704 with a washer, lock-washer and nut combination 707. As further shown in FIG. 7, a first stabilizer fork 114 is secured to first trench access post 408 of front panel 102 by sliding mounting pin 902 of a first stabilizer fork into a bottom end of first trench access post 408, aligning through holes 910 in the stabilizer fork mounting pin 902 with stabilizer fork mount through holes 436 in first trench access post 408, inserting locking pin 708 through the aligned holes and securing locking pin 708 in place by inserting a cotter pin, not shown, through a tip of locking pin 708. A second stabilizer fork 114 is secured to second trench access post 409 of front panel 102 by sliding mounting pin 902 of a second stabilizer fork into a bottom end of second trench access post 409, aligning through holes 910 in the stabilizer fork with through holes 437 in second trench access post 409, inserting locking pin 710 through the aligned holes and securing locking pin 710 in place by inserting a cotter pin, not shown, through a tip of locking pin 710.

FIG. 8 is a perspective detail view of a hinge and gate assembly 112 that is mounted across the trench access threshold 406, as described above with respect to FIG. 7. As shown in FIG. 8, hinge and gate assembly 112 includes a door 802 connected to a hinge 804 with through holes 806 that is used to mount hinge and gate assembly 112 to the trench access threshold provided in front panel 102, as described above.

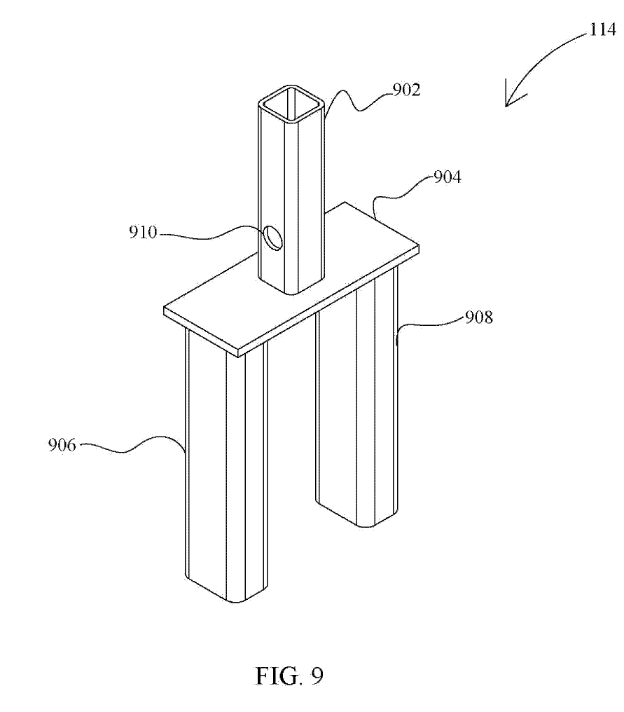

FIG. 9 is a perspective detail view of a stabilizer fork shown in the gate assembly shown in FIG. 7. As shown in FIG. 9, a stabilizer fork 114 includes a mounting pin 902 fixed to an upper face of a base plate 904 and includes fork prong 906 and fork prong 908 fixed to a lower face of base plate 904 with a space between fork prong 906 and fork prong 908 that is slightly greater than the width of an upper edge 18 of a trench shield panel 12. Thus, when mounted to a trench access threshold of a front panel, as described above with respect to FIG. 7, stabilizer fork 114 stabilizes the trench access threshold against opposite sides of the trench shield panel to which the front panel is mounted.

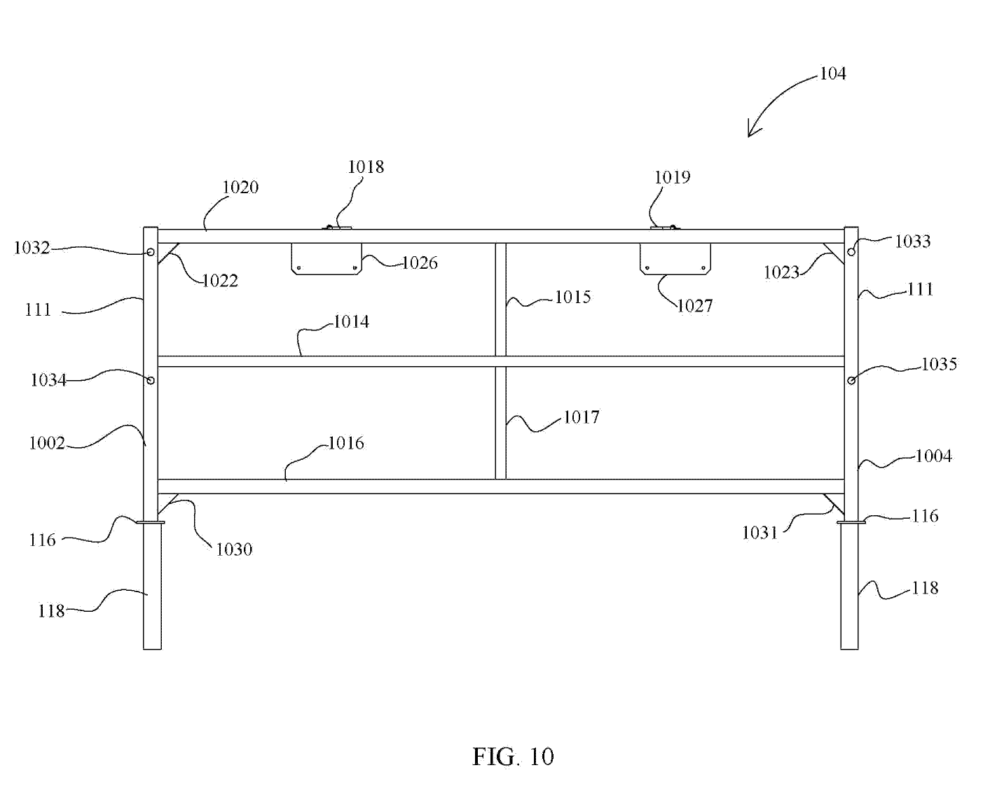

FIG. 10 is a plan view of a back panel shown in the temporary safety guard rail system of FIG. 1, FIG. 2 and FIG. 3. As shown in FIG. 10, back panel 104 includes a first corner post 1002 and a second corner post 1004 joined together by an upper railing assembly 1020, a middle railing 1014 and a lower railing 1016. Back panel 104 further includes an upper mid-section vertical support 1015 that connects a mid-section of upper railing assembly 1020 to a mid-section of a middle railing 1014, and includes a lower mid-section vertical support 1017 that connects a mid-section of middle railing 1014 to a mid-section of a lower railing 1016. Together, upper mid-section vertical support 1015 and lower mid-section vertical support 1017 is used to fuse upper railing assembly 1020, middle railing 1014 and lower railing 1016 into a more integral unit and thereby strengthens and stiffen back panel 104.

Corner post 1002 and corner post 1004 are similar in configuration and each includes a vertical rail 111, a base plate 116 and a mounting pin 118, as described above with respect to corner posts used in front panel 102, described above with respect to FIG. 4.

Upper railing assembly 1020 is connected at one end to the top of vertical rail 111 of first corner post 1002, the connection is structurally reinforced by a triangular brace 1022. Upper railing assembly 1020 is connected at an opposite end to the top of railing support 11 of second corner post 1004, the connection is structurally reinforced by a triangular brace 1023. Middle railing 414 is connected at one end to a mid-section of vertical rail 111 of corner post 1002, and at an opposite end to a mid-section of vertical rail 111 of corner post 1004. Lower railing 416 is connected at one end to the bottom of vertical rail 111 of corner post 1002, and at an opposite end to a bottom of vertical rail 111 of corner post 1004. The connections between lower railing 1016 and the bottom of vertical rail 111 of corner post 1002 and between lower railing 1016 and the bottom of vertical rail 111 of corner post 1004 is structurally reinforced by triangular brace 1031 and triangular brace 1030, respectively.

Upper railing assembly 1020 includes a D-ring bracket 1018, D-ring bracket 1019, notice mounting plate 1026 and notice mounting plate 1027. D-ring bracket 1018 and D-ring bracket 1019 are connected to a horizontal upper face of upper railing assembly 1020 to provide connection points for worker safety harnesses and/or for use in hanging back panel 104 when not in use. Notice mounting plate 1026 and notice mounting plate 1027 are connected to a horizontal lower face of upper railing assembly 1020 to provide supports for attaching, for example, warning signs and reflectors.

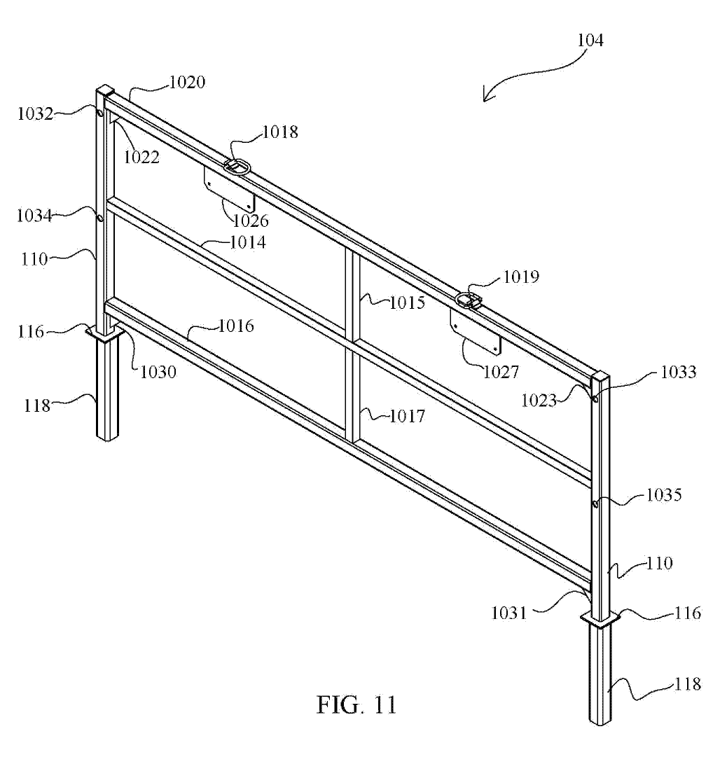

FIG. 11 is a perspective view of the back panel 104 described above with respect to FIG. 10. As shown in FIG. 11, a large number of the components of a back panel embodiment shown in FIG. 11 may be constructed of square hollow tubing, however, other types of solid bar stock and/or hollow bar stock of a wide range of materials could be used.

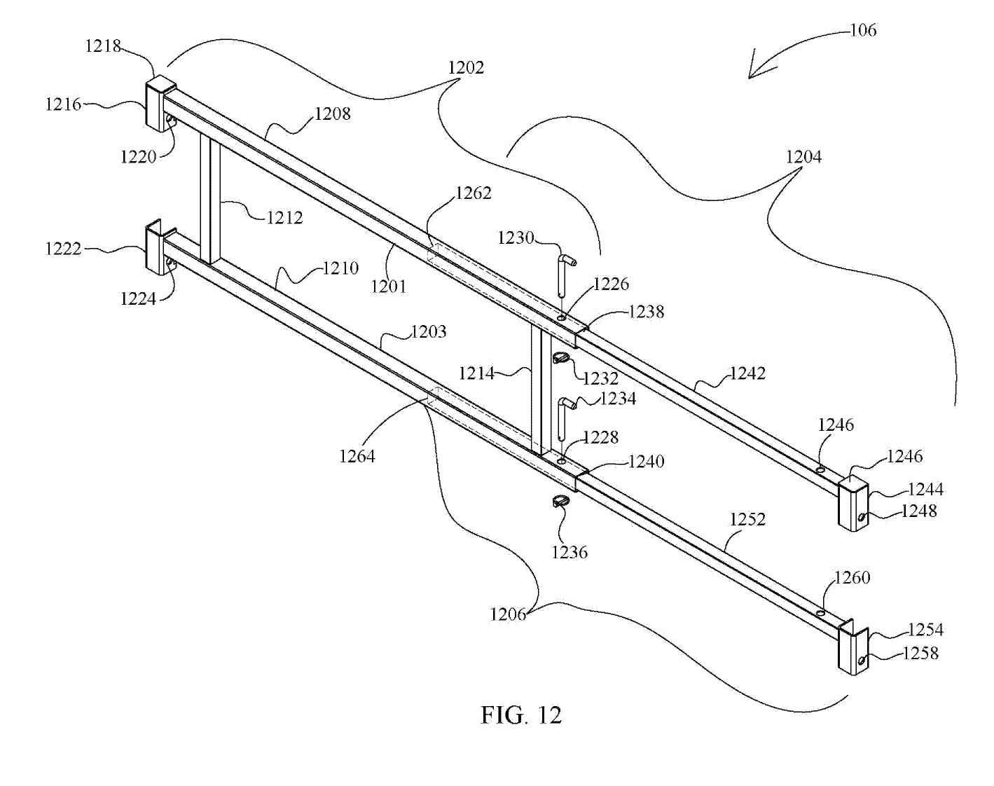

FIG. 12 is a perspective view of a side panel 106, or spreader panel, described above with respect to the temporary safety guard rail system of FIG. 1, FIG. 2 and FIG. 3. As shown in FIG. 12, side panel 106 includes a fixed dual spreader arm 1202, an upper inner spreader arm 1204 and a lower inner spreader arm 1206.

Fixed dual spreader arm 1202 includes a fixed upper arm assembly 1201, a fixed lower arm assembly 1203, a first vertical brace 1212, and a second vertical brace 1214. Fixed upper arm assembly 1201 includes a hollow fixed upper arm 1208 and an end bracket 1216. A first end of hollow fixed upper arm 1208 is terminated with end bracket 1216, a second end of hollow fixed upper arm 1208 terminates in an open end 1238. End bracket 1216 includes an end bracket top plate 1218 and a horizontal through hole 1220. Open end 1238 of hollow fixed upper arm 1208 includes a through hole 1226. Fixed lower arm assembly 1203 includes a hollow fixed lower arm 1210 and an end bracket 1222. A first end of hollow fixed lower arm 1210 terminates with end bracket 1222, a second end of hollow fixed lower arm 1210 terminates in an open end 1240. End bracket 1222 includes a horizontal through hole 1224. Open end 1240 of hollow fixed lower arm 1210 includes a through hole 1228. First vertical brace 1212 joins hollow fixed upper arm 1208 to hollow fixed lower arm 1210 at ends adjacent to end bracket 1216 and end bracket 1222, respectively. Second vertical brace 1214 joins hollow fixed upper arm 1208 to hollow fixed lower arm 1210 at ends adjacent to open end 1238 and open end 1240, respectively.

Upper inner spreader arm 1204 includes a inner arm 1242 and an end bracket 1244. A first end of inner arm 1242 is terminated with end bracket 1244, a second end of inner arm 1242 terminates in an open end 1262. End bracket 1244 includes an end bracket top plate 1246 and a horizontal through hole 1248. Inner arm 1242 includes a through hole 1246 adjacent to the end to which bracket 1244 is attached.

Lower inner spreader arm 1206 includes an inner arm 1252 and an end bracket 1254. A first end of inner arm 1252 is terminated with end bracket 1254, a second end of inner arm 1252 terminates in open end 1264. End bracket 1244 includes a horizontal through hole 1258. Inner arm 1252 includes a through hole 1260 adjacent to the end to which bracket 1254 is attached.

In one embodiment, inner arm 1242 of upper inner spreader arm 1204 includes one or more through holes 1246 which may be selectively aligned with through hole 1226 of hollow fixed upper arm 1208. A locking pin 1230 is passed through the aligned holes and held in place with cotter pin 1232 to hold inner arm 1242 at a fixed position relative to hollow fixed upper arm 1208. Inner arm 1252 of lower inner spreader arm 1206 includes one or more through holes 1260 which may be selectively aligned with through hole 1228 of hollow fixed lower arm 1210. A locking pin 1234 is passed through the aligned holes and held in place with cotter pin 1236 to hold inner arm 1252 at a fixed position relative to hollow fixed lower arm 1210. In this manner, side panel 106 is set to one or more fixed variable lengths.

Upper inner spreader arm 1204 and lower inner spreader arm 1206 each slide into hollow fixed upper arm 1208 and hollow fixed lower arm 1210 of fixed dual spreader arm 1202, respectively, thereby allowing the length of side panel 106 to be adjustable. Upper inner spreader arm 1204 and lower inner spreader arm 1206 are each fixed to hollow fixed upper arm 1208 and hollow fixed lower arm 1210, respectively, at predetermined through hole locations with a locking pin and cotter pin to fix side panel 106 to one or more fixed lengths.

It is noted that inner arm 1242 and inner arm 1252 are of the same length. Inner arm 1242 may insert within and slide into hollow fixed upper arm 1208 for the entire length of inner arm 1242 and inner arm 1252 may insert within and slide into hollow fixed lower arm 1210 for the entire length of inner arm 1252. Therefore, assuming that inner arm 1242 and inner arm 1252 are equal in length, and equal insertion lengths, or overlap lengths, of each are inserted within the hollow arms of fixed dual spreader arm 1202, side panel 106 may be set to any variable length less than the combined total lengths of fixed dual spreader arm 1202 and the common length of upper inner spreader arm 1204 and lower inner spreader arm 1206, minus 2 times the overlap length. Assuming that through hole 1226 of hollow fixed upper arm 1208 is aligned with a through hole in inner arm 1242 and that through hole 1228 of hollow fixed lower arm 1210 is aligned with a through hole in inner arm 1252, the length of side panel 106 may be fixed with locking pins, as described above. It is recognized that mechanisms other than locking pins and through holes, e.g., thumb screws, clamps, etc., may be used to hold inner arm 1252 and inner arm 1252 within their respective hollow fixed arms at a desired variable length which does not require the alignment of through holes, as described above, such embodiments are considered within the scope of this invention.

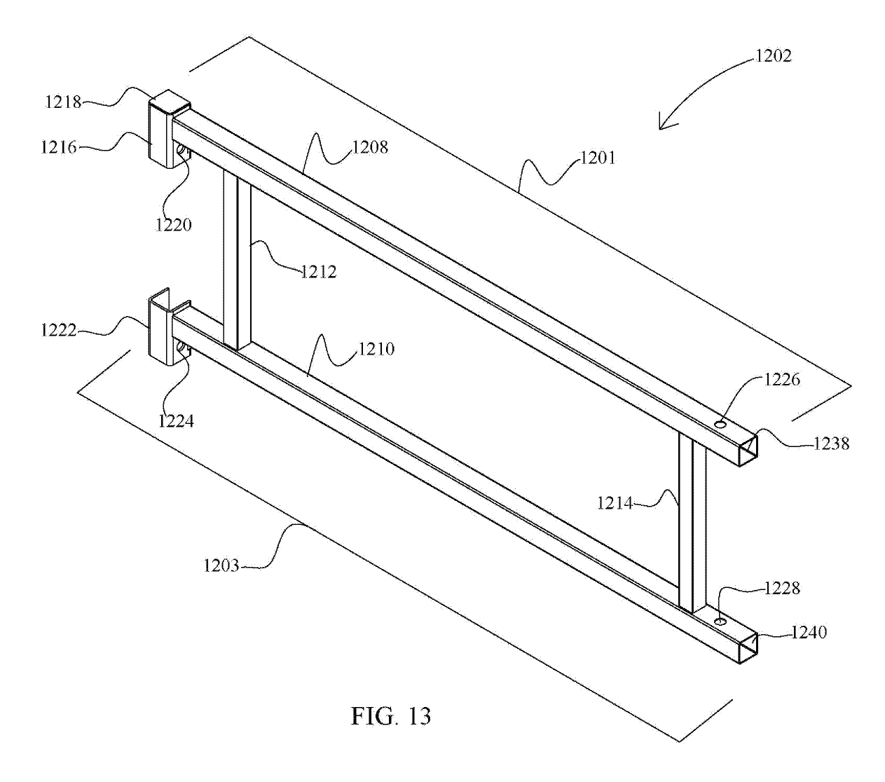

FIG. 13 is a perspective view of a fixed dual spreader arm 1202, described above with respect to FIG. 12. As shown in FIG. 13, a large number of the components of a fixed dual spreader arm embodiment may be constructed of square hollow tubing, however, other types of solid bar stock and/or hollow bar stock of a wide range of materials could be used. Further, bracket 1216 and 1222 includes rectangular cavities capable of receiving upper and mid-sections of a vertical rail 111 of a corner post 110, as described above.

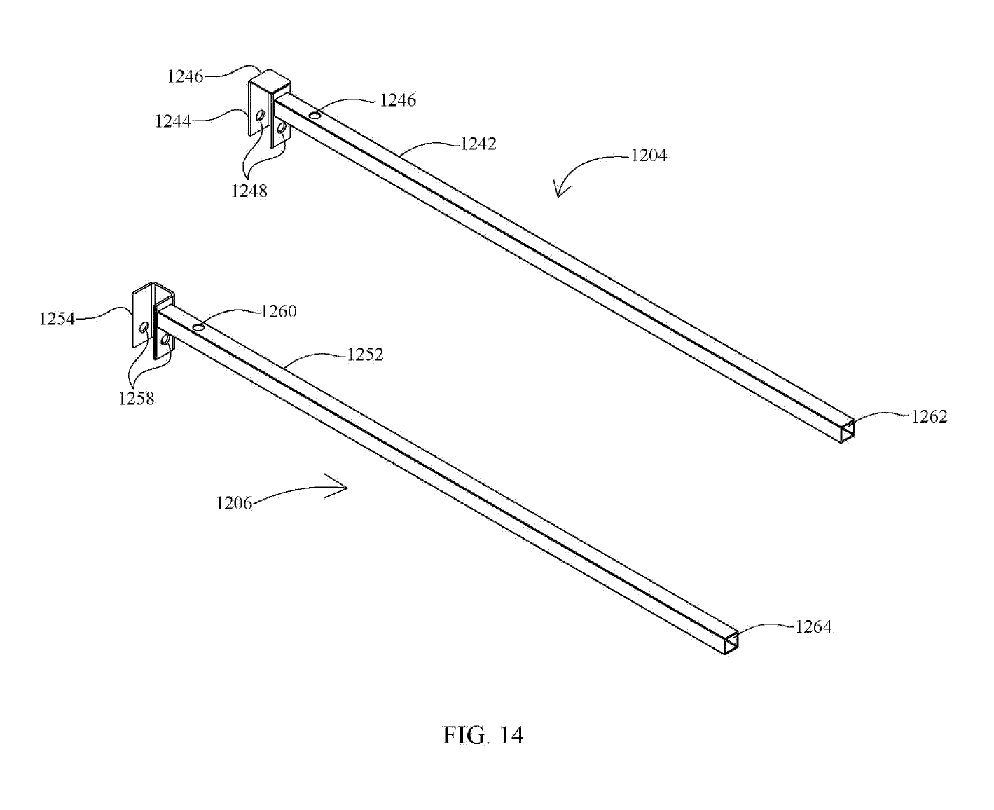

FIG. 14 is a perspective view of an upper inner spreader arm 1204 and a lower inner spreader arm 1206, as described above with respect to FIG. 12. As shown in FIG. 14, a large number of the components of an upper inner spreader arm 1204 and a lower inner spreader arm 1206 may be constructed of square hollow tubing, however, other types of solid bar stock and/or hollow bar stock of a wide range of materials could be used. Further, bracket 1216 and bracket 1222 includes rectangular cavities capable of receiving upper and mid-sections of a vertical rail 111 of a corner post 110, as described above.

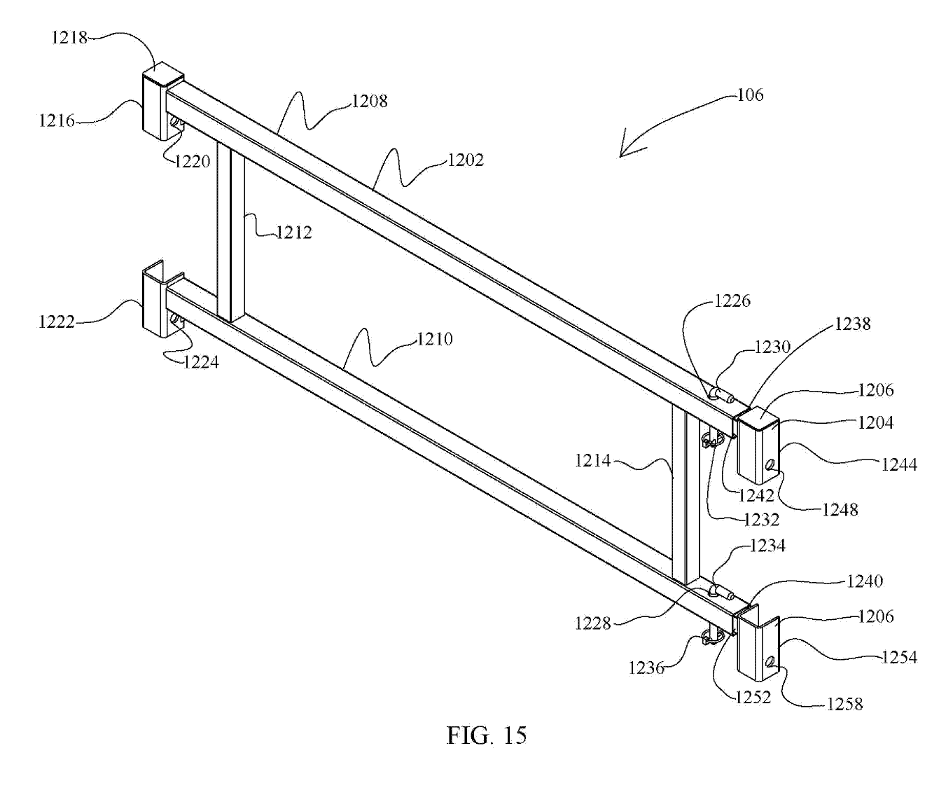

FIG. 15 is an perspective view of the side panel 106 of FIG. 12 in which inner arm 1242 is shown inserted within hollow fixed upper arm 1208 for the entire length of inner arm 1242 and inner arm 1252 is shown inserted within hollow fixed lower arm 1210 for the entire length of inner arm 1252. Through hole 1226 of hollow fixed upper arm 1208 is aligned with through hole 1246 in inner arm 1242 and fixed in place with locking pin 1230 and cotter pin 1232. Through hole 1228 of hollow fixed lower arm 1210 is aligned with through hole 1260 in inner arm 1252 and fixed in place with locking pin 1234 and cotter pin 1236. As shown in FIG. 15, side panel 106 is in a fully contracted fixed configuration.

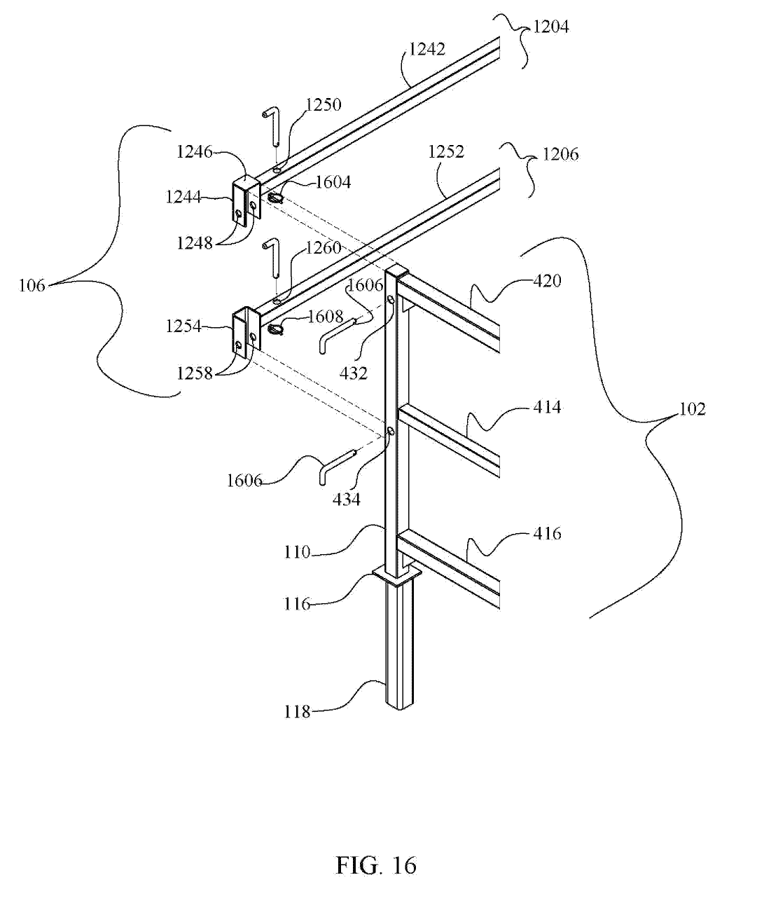

FIG. 16 is an exploded perspective detail view of a first corner post assembly shown in FIG. 3 at 120. As shown in FIG. 16, an upper inner spreader arm 1204 of a variable length side panel 106 is connected to an upper vertical end of a corner post 110 of front panel 102 by placing end bracket 1244 of upper inner spreader arm 1204 over the upper vertical end of the corner post, aligning through holes 432 in the upper end of the corner post with through holes 1248 in end bracket 1244, inserting locking pin 1602 through the aligned holes and securing locking pin 1602 in place by inserting cotter pin 1604 through a tip of locking pin 1602. As further shown in FIG. 16, an lower inner spreader arm 1206 of a variable length side panel 106 is connected to a midsection area of the corner post of front panel 102 by placing bracket 1254 of lower inner spreader arm 1206 over a midsection area of the corner post, aligning through holes 434 in the midsection area of the corner post with through holes 1258 in end bracket 1254, inserting locking pin 1606 through the aligned holes and securing locking pin 1606 in place by inserting cotter pin 1608 through a tip of locking pin 1606. A similar corner post assembly is assembled between a variable length side panel 106 and a corner post 110 of a back panel 104.

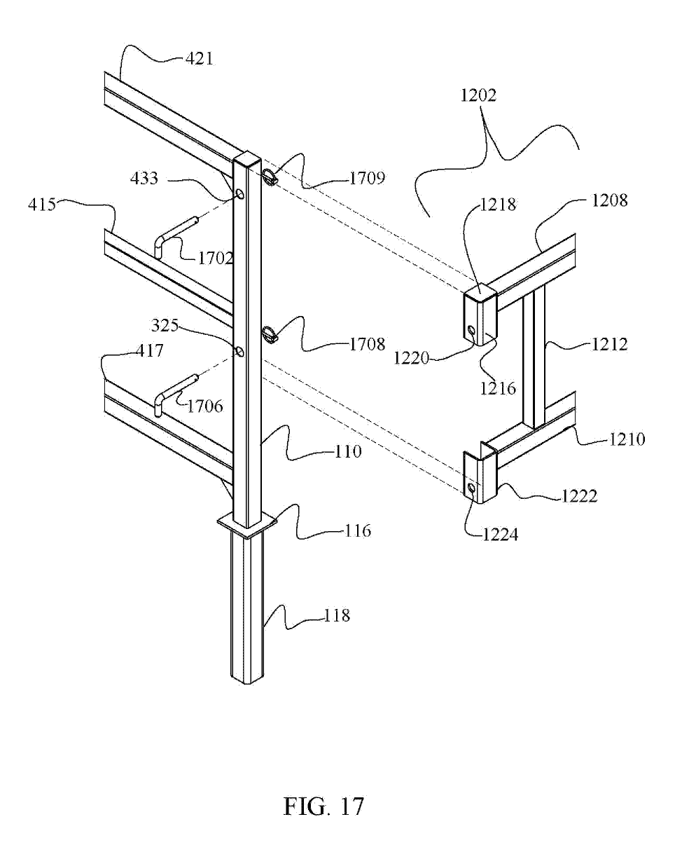

FIG. 17 is an exploded perspective detail view of a second corner post assembly shown in FIG. 3 at 140. As shown in FIG. 17, a fixed upper arm 1208 of a variable length side panel 106 is connected to an upper vertical end of a corner post of front panel 102 by placing end bracket 1216 of fixed upper arm 1208 over the upper vertical end of the corner post, aligning through holes 433 in the upper end of the corner post with through holes 1220 in end bracket 1216, inserting locking pin 1702 through the aligned holes and securing locking pin 1702 in place by inserting cotter pin 1704 through a tip of locking pin 1702. As further shown in FIG. 5, an fixed lower arm 1210 of a variable length side panel 106 is connected to a midsection area of a corner post of front panel 102 by placing bracket 1222 of fixed lower arm 1210 over a midsection area of the corner post, aligning through holes 435 in the midsection area of the corner post with through holes 1224 in end bracket 1222, inserting locking pin 1706 through the aligned holes and securing locking pin 1706 in place by inserting cotter pin 1708 through a tip of locking pin 1706. A similar corner post assembly is assembled between a variable length side panel 106 and a corner post 110 of a back panel 104.

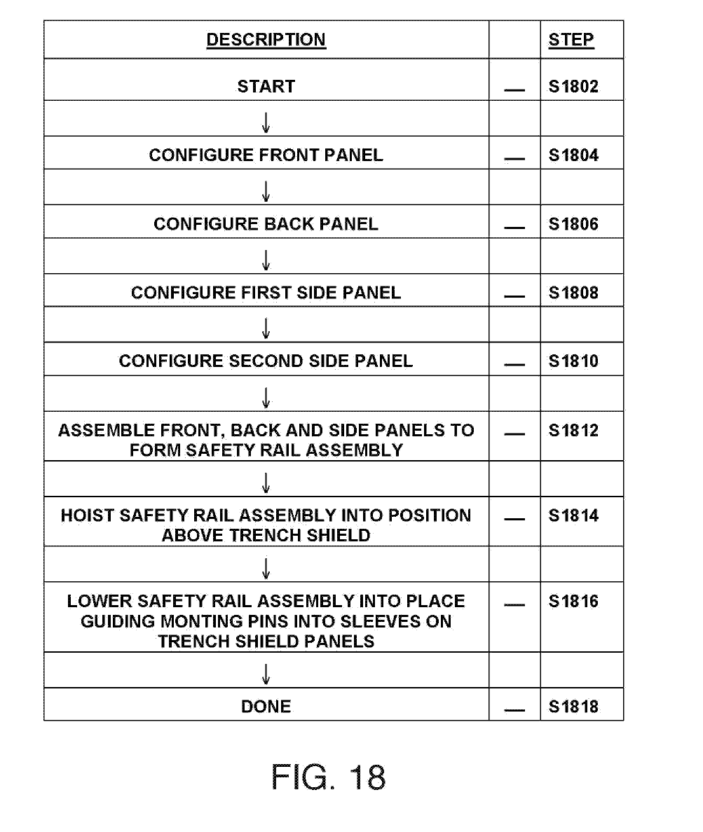

FIG. 18 is a flow diagram of an process that is used to safeguard an open hole or trench using an embodiment of the described safety rail system 100 of the present invention. In the process below, it is assumed that a trench or hole has been dug, and that a trench shield, or trench shore, has been installed in the trench to protect against potential cave-ins of the trench, but that no measures have yet been taken to safeguard the hole or trench from persons and equipment from accidentally falling into the excavated area. As shown in FIG. 18, operation of the process begins at step S1802 and processing proceeds to step S1804.

In step S1804, a selected front panel may be optionally configured for compatibility with the trench shield to which it is to be attached, and operation of the process proceeds to step S1806. In this step, a stabilizer fork 114 with a space between fork prong 906 and fork prong 908 that is slightly greater than the width of an upper edge 18 of a trench shield panel 12, as described above with respect to FIG. 9, is selected and attached to each of first trench access post 408 and second trench access post 409 with locking pins and cotter pins, or other connection technique. Further, if the front panel supports configurable trench shield mounting pins, as described above, a trench shield mounting pin with a corresponding mating shape on a trench shield is selected and attached to the respective corner posts of the front panel with locking pins and cotter pins, or other connection technique. In addition, the front panel is configured with a safety door, as described above with respect to FIG. 7, or other barrier, may optionally be mounted across the front panel trench access threshold

In step S1806, a selected back panel may be optionally configured for compatibility with the trench shield to which it is to be attached, and operation of the process proceeds to step S1808. This optional step is similar to step S1804 in that if the back panel supports configurable trench shield mounting pins, as described above, a trench shield mounting pin with a corresponding mating shape on a trench shield is selected and attached to the respective corner posts of the back panel with locking pins and cotter pins, or other connection technique.

In step S1808, a first side panel may be optionally configured to an appropriate length to span a distance between adjacent front panel and back panel corner posts on opposite sides of the trench, and operation of the process proceeds to step S1810.

In step S1810, a second side panel may be optionally configured to an appropriate length to span a distance between adjacent front panel and back panel corner posts on opposite sides of the trench, and operation of the process proceeds to step S1812.

In step S1812, the front panel, back panel and side panels are assembled to form a safety rail system, as described above with respect to FIG. 1, FIG. 2 and FIG. 3, and operation of the process proceeds to step S1814. For example, in step S1812, the front panel and back panels is joined via their respective corner posts to the respective side panels using locking pins and cotter pins, as described above with respect to FIG. 16 and FIG. 17, to form a full safety rail system 100.

In step S1814, the assembled safety rail system is hoisted by a crane, or other lifting device, by cables attached to the D-ring assemblies attached to the top rail of the front panel and the back panel of the safety rail system, as described above with respect to FIG. 4, FIG. 6, FIG. 10 and FIG. 11, and operation of the process proceeds to step S1816.

In step S1816, the safety rail system is guided into position above a trench shield, e.g., a trench shield in place within an excavated trench or hole, and lowered into place as the shield mounting pins are guided into mounting sleeves 22 added to the panels of the trench shield, as shown in FIG. 1, and operation of the process proceeds to step S1818 and terminates.

Referring to FIGS. 1-18, it can be seen that the preferred guard rail system is to be mounted via corner posts 110 on sleeves, such as mounting sleeves 22 added to the trench shield panels shown in FIG. 1. Stabilizer forks 114 project down from the vertical members forming the threshold of the front panel, so as to provide a stable and reinforced mount on opposite sides of a trench shield panel. Gate 112 in FIG. 1 is mounted in the central opening in the front panel. Workers entering or leaving via gate 112 can attach their harness leashes to the D-ring mounted in the threshold. Gate 112 can be separately purchased from a supplier of safety gates used for other purposes. Base plates 116 on the corner posts limit the travel of corner posts 110 into mounting sleeves 22, and preferably provide a flush and level mount with the top edge of mounting sleeves 22. With the configuration shown in FIG. 1, the guard rail system is preferably at a height above the surface surrounding an excavated area or opening to permit one to grip the top rail when outside (i.e., hence, the system is also referred to as a hand rail). With the rail system mounted as shown in FIG. 1, it would not be possible to move the rail system horizontally or at an angle without moving the trench shield or bending or breaking the rail system. Preferably, the rail can withstand 200 PSI stresses without bending or breaking. Components formed of tubular materials preferably have end caps to bar water or corrosive agents, and preferably the end caps substantially reduce if not eliminate edges that may catch on persons or equipment. End caps can be of metal or plastic coated metal or made entirely of a suitably strong plastic. In an embodiment, metal end caps are used that enhance the structural integrity of tubular components.

While the rail system illustrated provides for spreaders to expand or contract their length to match the width of a particular trench shield, another embodiment is envisioned wherein the front and back panel will have adjustable lengths. In a further embodiment, all panels are of adjustable length. In another embodiment, stabilizer forks 114 may be optionally left out and/or additional stabilizer forks may be used. The attachment of corner posts 110 to a trench shield may be modified, for example, by replacing one or more of the trench shield mounting pins extending below base plates 116 with forms that correspond to a corresponding mating shape on a trench shield. In such embodiments, a corner post within a safety rail system 100 may be configured with one of a selection removable trench shield mounting pins. In one such embodiment, a removable trench shield mounting pin is attached to a bottom of a vertical rail 111 of a corner post 110 in a manner similar to that used to attach a stabilizer fork 114 to a trench access post.

For example, a removable trench shield mounting pin includes a railing support mounting pin fixed to an upper horizontal face of base plate 116 and a mounting pin 118 mounted to a lower horizontal face of base plate 116. The selected removable trench shield mounting pin attaches to a railing support by sliding the railing support mounting pin into the bottom of a vertical rail 111, aligning a through hole in the railing support mounting pin with a through hole in the bottom of a vertical rail 111, passing a locking pin through the aligned holes and securing the locking pin in place with a cotter pin. In such a manner, a front panel 102 and a back panel 104 are configurable to attach to a wide variety of trench shields, e.g., trench shields with different shaped sleeves.

Referring to locking pins mounted in corresponding holes in the components, it can be seen that the panels and components can be readily assembled and disassembled, permitting ready reconfiguration, and permitting the system to be collapsed into a small area for storage and transportation. Use of the present invention does not require additional space around an excavated area or opening in which the system is mounted, and its secure attachment to a trench shield or similar equipment, provides security to workers inside and outside the excavated area or opening.

It is noted that exemplary embodiments of the described safety rail system 100 may be installed using a front panel that does not include a trench access threshold. Such a configuration is assembled using two back panels in place of one back panel and one front panel as described with respect to embodiments above. It is further noted that exemplary embodiments of the described safety rail system 100 may be installed using a back panel that includes a trench access threshold. Such a configuration is assembled using two front panels in place of the one back panel and the one front panel as described with respect to embodiments above.

Although the above exemplary safety rail system 100 embodiments have been described with respect to use with trench shields, it is envisioned that safety rails in accordance with the present invention may also be used with trench shores.

It is further envisioned that safety rails in accordance with the present invention may be of different shapes and appearance without departing from the spirit of the invention. While steel is a preferred construction material, it is envisioned that other embodiments may include some or all components made of aluminum and/or other materials having sufficient properties to meet the expected demands. Surfaces may include coatings that resist corrosion, provide a better grip, facilitate cleaning, enhance visibility (including attachment of reflective devices), and/or reduce the dangers or effects of impacts. Surfaces may also be engineered to have improved grip.

The claims as submitted with the application as filed describe the scope of protection for which the inventor initially seeks protection, but do not waive applicant's right to subsequently file claims of broader scope or to seek claims directed to different inventions described by the specification as filed and the inventions embodied by the figures as filed. To the extent terminology of the claims at the time of filing does not exactly match terminology in the preceding description or the abstract of this application as filed, such terminology is to be considered part of the foregoing description as of the filing date. Likewise, to the extent the written description of the invention does not reflect all of the features of the inventions shown in the figures, applicant does not waive the right to subsequently claim such inventions and to amend the written description accordingly. The initial claims should not be deemed to be a limit as to the scope and variety of claims to which applicant is entitled and may seek during the pendency of the subject application and any divisions, continuations or other applications that claim priority thereof.

The present inventions have been described with respect to preferred embodiments thereof. Applicant's description of these preferred embodiments is not intended to restrict the scope of protection available to the applicant or that may be sought by applicant for the present inventions. Many changes and modifications in the embodiments described and illustrated can be carried out without departing from the scope and the spirit of applicant's inventions incorporated into this application.

I claim:

1. A safety guard rail system capable of being mounting to a trench shield or shore, comprising:
a front panel having a first front corner post and a second front corner post;
a back panel having a first back corner post and a second back corner post;
a first side panel operatively connectable to said front panel and to said back panel, and a second side panel operatively connectable to said front panel and to said back panel,
wherein said first side panel and said second side panel can span a separation between a first trench shield panel to which said front panel can be mounted and a second trench shield panel to which said back panel can be mounted.

2. The safety guard rail system of claim 1, wherein said first side panel and said second side panel each has a front side panel end and a back side panel end, wherein each said side panel end is operatively connectable to one of said corner posts,
whereby,
when said front panel first front corner post is operatively connected to said front end of said first side panel and said front panel second front corner post is operatively connected to said front end of said second side panel, and
when said back panel first back corner post is operatively connected to said back end of said first side panel and said back panel second back corner post is operatively connected to said back end of said second side panel, and
when said front panel is operatively mounted to the top of a first trench shield panel and said back panel is operatively mounted to a second trench shield panel, the trench shield panels being operatively connected in spaced relationship to create a cavity therebetween,
said front, back, first side and second side panels rise upwards to create a continuous wall above the upper perimeter of the cavity between the portions of the trench shield first and second panels to which said front and back panels are mounted.

3. The safety guard rail system of claim 1, wherein at least one panel further comprises:
at least one mounting pin, wherein said at least one mounting pin is located in a position on said at least one panel so as to permit insertion into a corresponding fitting on a trench shield to which said system is mounted, or wherein said mouting pin will engage either an inner or outer surface of a trench shield to which said system is mounted to limit horizontal movement of said system with respect to the trench shield when mounted thereon.

4. The safety guard rail system of claim 3, wherein each of said front panel and said back panel has at least one of said at least one mounting pin, wherein said mounting pins extend downward from one of said corner posts of each said front panel and said back panel, wherein each said mounting pin further comprises a base plate of dimensions sufficient to maintain said front and back panels at a minimum height above a trench shield on which said system is mounted.

5. The safety guard rail system of claim 4, further comprising a trench shield or shore, said trench shield or shore having first and second panels that can be held in spaced relationship, wherein when said front and back panels are operatively connected by said first and second side panels, and when said trench shield or shore first and second panels are held at a distance corresponding to the space between said front and back panels, said mounting pins can be aligned with and inserted into corresponding sleeves in said first and second panels of said trench shield or shore so that said base plates maintain the minimum elevation with respect to said trench shield or shore of said front panel, back panel, first side panel and second side panel, or said mounting pins and said base plates engage the upper portions of said trench shield or shore first and second panels to maintain the minimum elevation with respect to said trench shield or shore of said front panel, back panel, first side panel and second side panel.

6. The safety guard rail system of claim 1, wherein said front panel further comprises an access threshold to permit ingress and egress through said front panel to the cavity formed between the portions of the trench shield first and second panels to which said front and back panels are mounted.

7. The safety guard rail system of claim 6, wherein said front panel further comprises a gate operatively connected to said front panel for permitting or blocking ingress and egress through said access threshold, wherein said access threshold comprises:
a first and second threshold post, each said threshold post having a bottom; and
a threshold rail that connects said bottom of said first threshold post to said bottom of said second threshold post.

8. The safety guard rail system of claim 7, wherein said front panel further comprises a stabilizer fork and a connection fitting, said stabilizer fork having at least a first prong and a second prong, said prongs projecting downward from said front panel to engage the upper portion of a panel of a trench shield or shore upon which said system is mounted, said connection fitting being proximate to said access threshold to permit workers and equipment to be operatively connected to said rail system.

9. The safety guard rail system of claim 1, wherein the length of said first and second side panels is adjustable.

10. The safety guard rail system of claim 9, wherein said first and second side panels each comprise at least one spreader member, each said spreader member having an inner and an outer spreader arm, wherein each said spreader arm has a panel connecting end portion for connecting said arm to said front panel or said back panel, and each said spreader arm has a spreader arm connecting portion for connecting said spreader arms to each other.

11. The safety guard rail system of claim 10, wherein said spreader arms each has at least one hole in said spreader arm connecting portion so that when at least one hole of said first spreader arm is aligned with at least one hole of said second spreader arm, a pin or bolt can be inserted through the aligned holes to fix the length of a said side panel comprised of said arms.

12. The safety guard rail system of claim 11, wherein said panel connecting end portions of said spreader arms comprise a corner post connection fitting that can be operatively engaged to one of said corner posts of said front and back panels.

13. The safety guard rail system of claim 12, wherein at least one said corner post connection fitting and at least one of said corner posts has at least one hole therein, wherein upon alignment of at least one hole in said corner post connection fitting with a said hole in a corner post engaged with said corner post connection fitting, a pin or bolt can be inserted though the aligned holes to fix said spreader member thereto.

14. The safety guard rail system of claim 13, wherein each said side panel comprises at least two spreader members, and said outer spreader arms are connected to each other.

15. A method of installing a safety railing for a trench fitted with a trench shield or a shore, wherein the trench shield or shore has panels operatively connected in spaced relationship to form a cavity having a perimeter defined by the panels of the trench shield or shore and the distance between the panels of the trench shield or shore, the method comprising mounting a safety railing onto the top of the trench shield or shore, wherein the safety railing has a front panel and back panel connected in spaced relationship by first side and second side panels, wherein the safety railing rises upwards from the upper perimeter of the cavity formed by the trench shield or shore to create a continuous wall above the upper perimeter of the cavity formed by the trench shield or shore.

16. The method of claim 15, further comprising the step of assembling the safety railing, said assembling step utilizing a front panel having a first front corner post and a second front corner post to a back panel having a first back corner post and a second back corner post, and a first side panel operatively connectable to said front panel and to said back panel, and a second side panel operatively connectable to said front panel and to said back panel,
said assembling step further comprising the steps of connecting the front panel first front corner post to the front end of the first side panel, connecting the front panel second front corner post to the front end of the second side panel, connecting the first back corner post of the back panel to the back end of the first side panel, and connecting the second back corner post of the back panel to the back end of the second side panel,
wherein the safety railing front and back panels are spaced apart by the first and second side panels by a distance about equal to the space between the first and second panels of the trench shield or shore, and
wherein said mounting step comprises mounting said railing onto the trench shield or shore so that the front panel is aligned about in the plane of the first panel of the trench shield or shore and the back panel is aligned about in the plane of the second panel of the trench shield or shore.

17. The method of claim 16, wherein said assembling step further comprises adjusting the length of the first and second side walls so that the distance between the front and back panel is about equal to the distance between the first and second panels of the trench shield or shore to which the safety rail is to be mounted.

18. A railing panel that attaches to a trench shield panel, comprising:
a plurality of posts, each of the plurality of posts comprising:
a railing support;
a trench shield mounting pin that fits within a sleeve on the trench shield panel;
a base plate located between the railing support and the trench shield mounting pin that limits a travel of the trench shield mounting pin into the sleeve;
a first rail that connects a top of the railing support of a first post of the plurality of posts to a top of the railing support of a second post of the plurality of posts; and
a second rail that connects another portion of the railing support of the first post to a corresponding another portion of the railing support of the second post.

19. The railing panel of claim 18, further comprising:
a threshold section comprising:
a first threshold post;
a second threshold post; and
a trench rail that connects a bottom of the first threshold post to a bottom of the second threshold post.

20. The railing panel of claim 18, further comprising:
a stabilizer fork that attaches to a bottom of at least one of the first threshold post and the second threshold post and attaches to an upper edge of the trench shield panel.
